(19) United States
(12) Patent Application Publication
(10) Pub. No.: US 2010/0185494 A1
(43) Pub. Date: Jul. 22, 2010

(54) METHOD FOR ACQUIRING, MANAGING AND PROCESSING INFORMATION CONCERNING THE DEGREE OF CUSTOMER SATISFACTION AND IT PRODUCT USING SUCH METHOD

(75) Inventor: Elio Marino, Segrate (Milano) (IT)

Correspondence Address: KING & SPALDING, 1185 AVENUE OF THE AMERICAS, NEW YORK, NY, 10036-4003, US

(73) Assignee: DENTSCAPE INC., Seattle, WA (US)

(21) Appl. No.: 12/664,447

(22) PCT Filed: Jun. 13, 2007
(86) PCT No.: PCT/IT2007/000416

§ 371 Date: Dec. 14, 2009

(51) Int. Cl. G06Q 10/00; G06F 17/30

(52) U.S. Cl. 705/10; 707/802; 707/E17.044

(57) ABSTRACT

The present invention relates to a method for acquiring, managing and processing information concerning the degree of customer satisfaction to provide information about the quality of the service offered by the activity center and an IT product using such acquiring method. Particularly, the method foresees the steps of providing a database (6) containing first statistically relevant data (5), said first statistically relevant data having been captured using a statistical technique (2A), providing a questionnaire (3A) which comprises a plurality of questions wherein a first set (3B) of said plurality of questions relates to the characteristics of said activity center and/or to the satisfaction degree of said user and a second set (3C) of said plurality of questions relates to the data of said user, receiving second statistically relevant data (7) representative of the answers to the plurality of questions proposed in the questionnaire (3A) and storing said second statistically relevant data (7) in said database (6). The method is characterized by evaluating said second statistically relevant data (7) as a function of said first statistically relevant data (5) so that each set (3B, 3C) of said plurality of questions that form said questionnaire (3A) is assigned a weight for generating second statistically relevant weighted data (13), by providing a summary measure (14) of said second statistically relevant weighted data (13) to determine a summary index (14A), said summary index (14A) allowing evaluation of the quality of the service offered by said activity center, said summary index (14A) including at least one alphanumeric judgment in a range of values from a minimum value to a maximum value and by generating at least one first report (15) representative of said summary index (14A).

The present invention relates to a method for acquiring, managing and processing information concerning the satisfaction degree of a user, particularly but without limitation for an activity center according to the preamble of claim 1.

The term “activity center” as used hereinafter is intended to mean any manufacturing and/or service enterprise, either polycentric or not, that can directly or indirectly supply goods and/or services to a customer/user.

Particularly, an activity center as defined above will be intended hereinafter as a dental center.

One of the major qualifying aspects for an activity center is the attainment of a high customer satisfaction degree.

This happens when the offered service fully coincides with customers' ideal service expectations.

In prior art, customer satisfaction (briefly referred to hereinafter as CS) is measured by submitting a series of specially designed questions to the user, to understand what his/her vision is like.

Nevertheless, CS surveys have a limited diffusion, for instance, in dental treatment centers, due to certain critical aspects, such as those listed below:

pre-designed surveys are poorly responsive and customizable to specific dental center situations, wherefore the creation of questionnaires complying to the requirements of various dental centers is difficult and time-consuming;

filling out questionnaires, generally submitted in electronic and/or paper form, is an excessively complex and/or time-consuming process;

transcription and analysis of the results obtained from paper questionnaires requires many man-hours, that dental centers generally cannot waste;

“unit” interpretation of data for specific survey areas is very difficult;

those that are designed to utilize these CS surveys cannot easily initiate practical corrective actions on the basis of data interpretations;

there is no strategy for implementation of corrective actions according to priority rules;

the use of external consultants increases CS survey costs, and causes the dental center to depend on consultants' advice, which is given by professionals that do not belong to this field of expertise and is often limited to general-purpose suggestions.

The above arguments show that a need is strongly felt in activity centers, such as the above mentioned dental centers, for a CS tool that is “flexible”, easily customizable and adaptable to activity centers of different sizes, that does not require data transcription and allows rapid analysis thereof, allows automatic data interpretation and proposal of corrective actions.

Therefore, the present invention is based on the issue of providing a method and an IT product for carrying out the method, that has such structural and functional characteristics as to fulfill the above need, while obviating the above prior art drawbacks.

This problem is solved by a method for acquiring, managing and processing information concerning the satisfaction degree of a user as defined in claim 1.

The problem is also solved by an IT product that can carry out said method as defined in claim 16.

This invention provides a method that uses appropriate statistical data processing techniques to express, once the sample has reached a statistically significant level, an analytical correlation between data results, automatically indicated interpretations and consequently suggested actions.

Furthermore, thanks to this novel method, each correlation value may be assigned a definite series of interpretations and corrective actions in each investigated area.

Also, when the collected data is processed using the present method it is represented in both synthetic and analytical forms.

It will be appreciated that synthetic representations may include, for instance, a list of suggestions which immediately recall the main corrective actions to be taken to address the problematic aspects encountered.

The analytical representation can utilize, for example, a specific graphical representation in which a color can be associated to each of the corresponding areas being analyzed.

Particularly, specific colors will be associated to each of the satisfaction level, information level, dissatisfaction level, or problematic situation, for timely highlighting the satisfaction degree of the activity center user.

Finally, the present invention provides an IT product that can be directly loaded into the memory of a computer system, which comprises program code portions, and is adapted to carry out the method when it runs on such computer system.

Further features and advantages of the present method and IT product using such method will be apparent from the following description of one preferred embodiment thereof, which is given by way of illustration and without limitation with reference to the accompanying figures, in which:

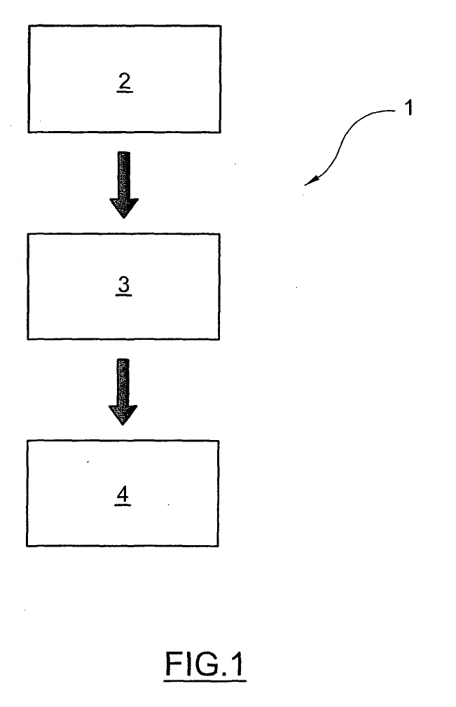

FIG. 1 is a flow chart of the method and IT product of the present invention;

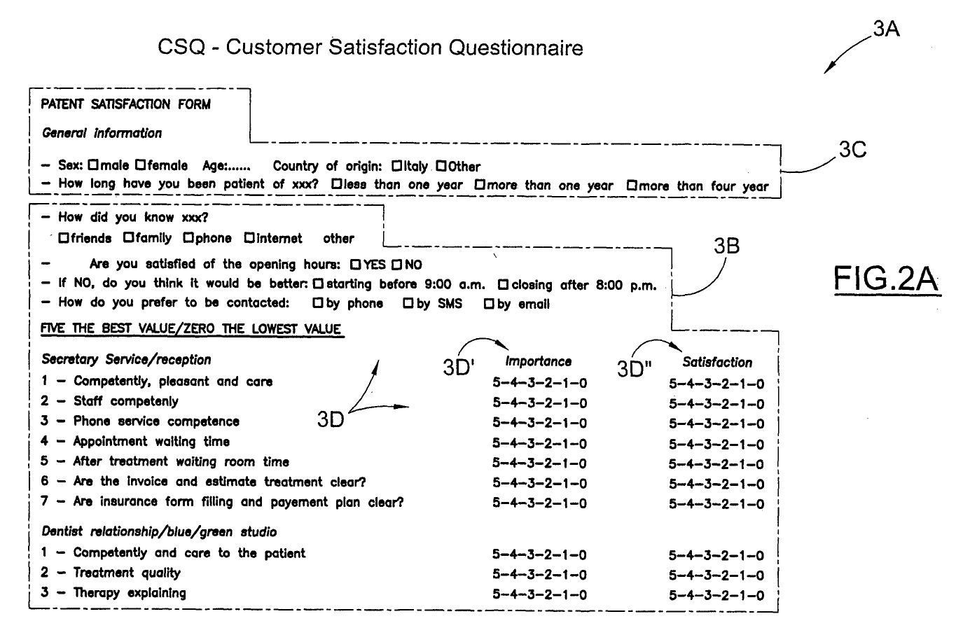

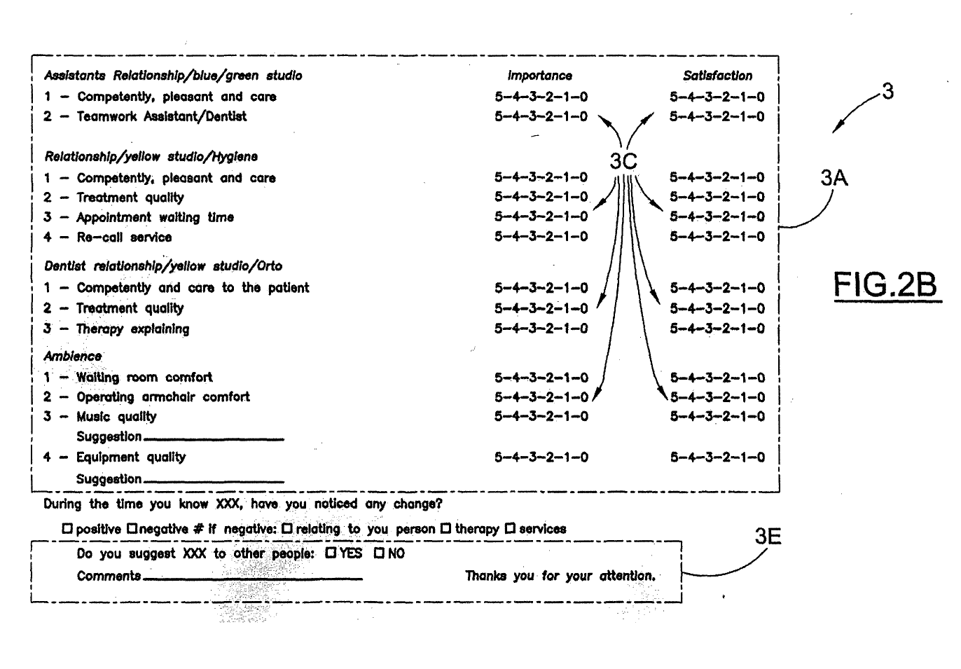

FIGS. 2A and 2B are graphical representations of a possible implementation of a plurality of questions of a CS survey questionnaire according to the present invention;

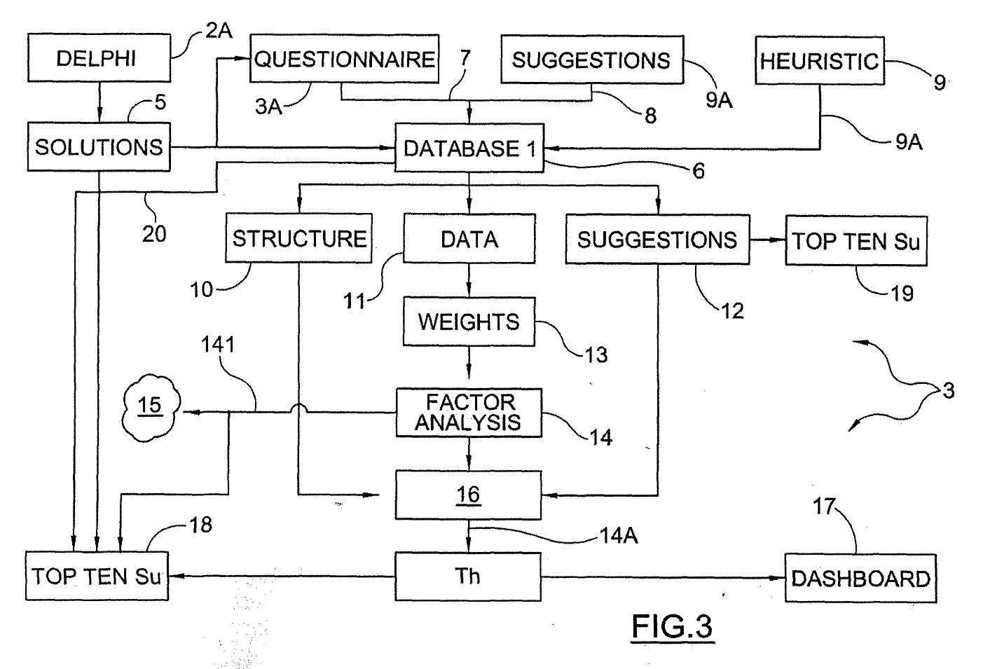

FIG. 3 is a flow chart of a particular step of the chart of FIG. 1, according to the present invention;

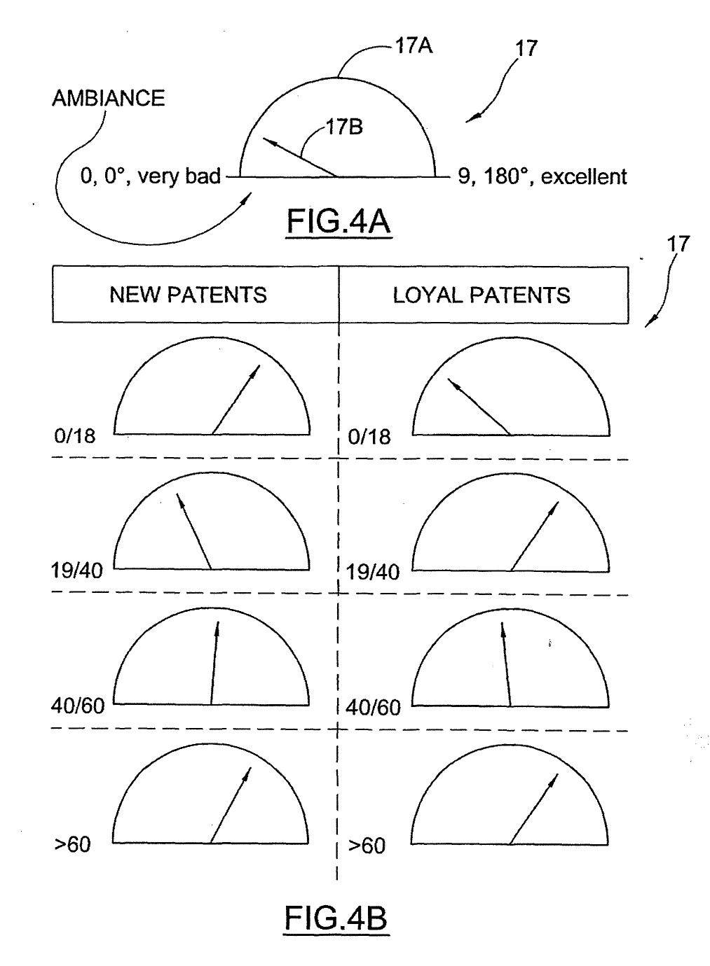

FIG. 4A shows a possible graphical representation of a synthetic index related to a specific set of said plurality of questions as shown in FIGS. 2A and 2B, such synthetic index resulting from the method of the present invention;

FIG. 4B shows a possible graphical representation of the index of FIG. 4A, as related to specific structure data resulting from the method of the present invention;

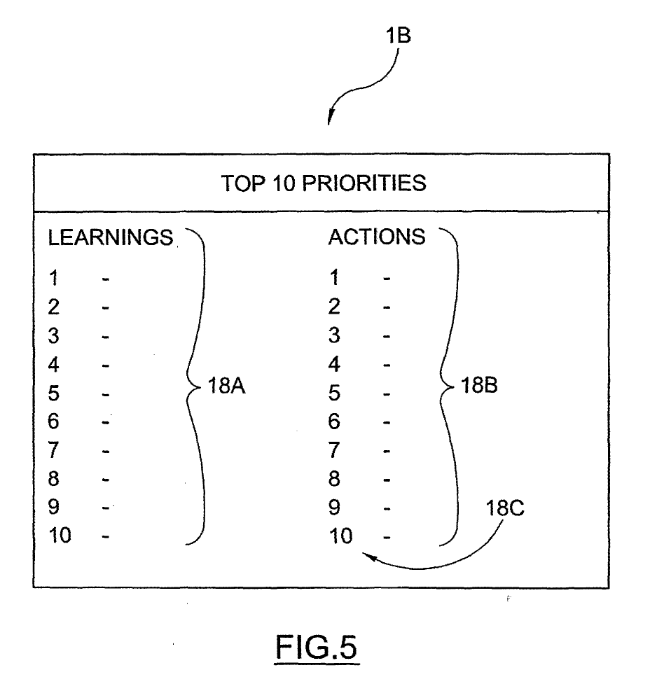

FIG. 5 shows a possible graphical representation of another synthetic index resulting from the method of the present invention.

Referring to the accompanying figures, numeral 1 generally designates the method for acquiring 2, managing and processing information 3 that can be used to determine the degree of satisfaction of a user through a report generation step 4 according to the present invention.

It will be immediately appreciated that such information may be received and transmitted by an activity center, such as a dental center.

Particularly, the step of acquiring 2 the information required for later processing 3 may be carried out as follows:

collecting data using a statistical technique 2A, such as Delphi and/or Focus Group, that can consolidate and detect solutions to CS-related issues in the specific field of the activity center;

collecting and aggregating data by administering a questionnaire 3A (FIGS. 2A and 2B) to customers/users of the activity center;

collecting and aggregating data through a form 4A containing spontaneous suggestions by the users of the activity center;

and, optionally, collecting heuristic data 9, i.e. concerning the specific skills acquired by the activity center with time.

In a preferred embodiment, the statistical technique 2A used in the present method is the “Delphi” statistical technique, which consists in a method for combining and synthesizing the forecasts of a panel of experts.

Particularly, the structure of the statistical technique 2A (Delphi) is designed to maximize the advantage of relying on a panel of experts (such as multidisciplinary knowledge and summarizing abilities) and minimize the disadvantages thereof (caused by social and personal divergences, etc.).

For the purposes of the present disclosure, this statistical technique 2A (Delphi) requires an initial document to be prepared, for defining the aims, the subject, and the type of experts being involved in the research, which will form the basis for the development of a series of questionnaires (not shown) to be filled by the experts, which will assist the development of questions to be subjected to quantitative evaluation in successive iterations, as a confirmation of the judgments of participants.

It will be appreciated that the statistical technique 2A (Delphi) used in the present method is based on four key principles, as listed below:

I°) anonymity, thanks to the use of private, specially designed questionnaires;

II°) iteration: the questionnaire is administered several times, and each expert is given the option to change his/her mind, without losing credibility with the other experts;

III°) controlled feedback: between one administration and the other, the coordinator informs each expert about the opinions of the other in anonymous and often statistical form;)

IV°) the final forecast is the result of a summary of the estimates of the experts expressed in the last round of the survey.

In other words, the statistical technique 2A (Delphi) allows generation of first statistically relevant data, said first data containing the solutions shared by the experts consulted for the specific area of the activity center.

This first statistically relevant data 5 may be stored in a database 6, as better explained hereafter.

Concerning the questionnaire 3A, an embodiment whereof is shown in FIGS. 2A and 2B, it is used as the data mining tool of the activity center.

Particularly, the questionnaire 3A comprises a plurality of questions, which may include the following sets:

a first set 3B of said plurality of questions is related to the activity center, the characteristics of said activity center (such as ambience, quality of services, etc.), and/or the degree of satisfaction of said user (i.e. the questions of the questionnaire) concerning the service offered by the activity center;

a second set 3C of said plurality of questions is related to the data of said user (date of birth, place of birth, residence, etc.).

The questionnaire 3A further includes a third set 3E of questions of said plurality of questions, which is related to suggestions, in which the user can enter notes and/or comments.

Further CS-related questions may be also added, such as those concerning activity center management.

It shall be noted that the first set 3B and/or the second set 3C of said plurality of questions that form the questionnaire 3A are constructed on the basis of said first statistically relevant data 5, i.e. the results obtained through the application of the first statistical technique 2A (Delphi).

In other words, the plurality of questions in the questionnaire 3A result from a processing based upon the first statistically relevant data 5 obtained through the application of the statistical technique 2A.

It should be highlighted that the second set 3C allows classification of the users that participate in the compilation of the questionnaire to identify the structural data of users, such as kind, age, loyalty to the activity center.

As shown in FIG. 2A, each question of the above mentioned sets of questions is associated a space for a judgment 3D, which is divided into an ideal judgment 3D′ (importance) and a real judgment 3D″ (satisfaction).

In other words, the judgment 3D identifies both the ideal importance level of the specific question contained in the questionnaire 3A and the actual satisfaction degree with respect to such specific question.

This judgment 3D, whether ideal or real, can be expressed by an alphanumeric notation in a range from a minimum value to a maximum value.

For example, in the specific representation of FIGS. 2A and 2B, values range from 1 to 5, but they may also range from very bad to excellent or on different scales, such as from 1 to 7 or from 0 to 5.

In other words, once the questionnaire 3A has been filled out by the user, second statistically relevant data 7 may be obtained. Advantageously, such second statistically relevant data 7 is also stored in the database 6.

Thus, this second statistically relevant data 7 is representative of the answers to the plurality of questions in said questionnaire 3A.

It should be noted that the step of acquiring data 2 from the questionnaire 3A may be carried out using one or more paper forms, according to the preferred embodiment or in a graphic form that can be displayed on a PC monitor, a tablet PC and/or similar PC products, used individually or over a network.

The interface for the activity center manager is designed for easy customization according to the size and operation of such activity center and can be embodied, for example, by one or more drop-down menus which allow the questionnaire to be customized by selecting the desired options.

The form-filling interface is quick and user-friendly, e.g. thanks to the use of the touch screen technology.

The questionnaire 3A may be administered to the customer/user at any time, i.e. before or after delivery of the activity center service and/or in any place, i.e. at the activity center or via the Internet.

It should be noted that, depending on the administration mode, a suitable weighting system is used for inquiry of CS issues to account for the different emotional states of the user.

In other words, the weighting system assigns a certain weight to an answer given by the user to one or more of the questions of the questionnaire 3A if, for instance, the user answers before delivery of the service by the activity center, as described below in greater detail.

Concerning the form 4A with spontaneous suggestions, these form third statistically relevant data 8 and may be directly collected by operators of the activity center upon contact with the customer/user and will be subjected to post encoding and processed as a complement to the analysis of the answers received from the filled out questionnaire 3A.

It should be noted that the suggestions so collected are subjected, if possible, to specific collection models, i.e. are designed to be entered in specific schemes, otherwise they can be free and unrestrained.

The suggestions contained in the form 4A are also advantageously stored in the database 6.

Such third statistically relevant data 8 is thus representative of the spontaneous suggestions provided by the customers/users of the activity center.

Concerning the heuristic data 9 of the activity center, this data is often available as representative of the history and experience of the activity center and may be used to evaluate/interpret/complement the data obtained from the statistical technique 2A and/or the questionnaire 3A.

Therefore, such heuristic data will form the fourth statistically relevant data 9A, also stored in the database 6.

In accordance with a preferred embodiment, the first 5, second 7, third 8 and/or fourth statistically relevant data 9A merge into the database 6, which may be periodically updated at varying intervals depending on the needs arising in the field of the activity center.

For example, if the questionnaire 3A is administered to the user/customer in paper form, the first 5, second 7 and third 8 statistically relevant data are manually entered in said database 6.

If the questionnaire 3A is filled out through the use of one or more of the above devices, such as a monitor of a PC, a tablet PC and/or similar products, operating individually or over a network, then such first 5, second 7 and third 8 statistically relevant data will be loaded on an automatic basis.

Advantageously, the database 6 collapses the first 5, second 7, third 8 and/or fourth 9A statistically relevant data thereby providing the possibility of harmonizing and defining relationships among the various sources across space, time and taxonomic scales.

In other words, the database 6 is suitably configured to provide homogeneity across space, time and taxonomic scales to such first 5, second 7, third 8 and/or fourth 9A statistically relevant data thereby creating content-specific data sets.

For instance, considering the time scale, the collected data might be converted from day units to week units.

Particularly, the database 6 is configured as composed of memory sections (or portions) each designed to store the following data:

a first section 10 for storing the structure data of said second relevant data 7, such as gender, age, loyalty of those that filled out the plurality of questions of the questionnaire 3A, which are advantageously processed in anonymous form and are assigned a unique code generated by a random process allowing to relate such structure information to the remaining sets of questions of the questionnaire;

a second section 11 for storing the data obtained from the questionnaire 3A, anonymously processed as described above and captured by space, time and taxonomic related modes;

a third section 12 for storing the sum of the third statistically relevant data 8 obtained both from the form 4A and from the suggestions 3E entered through the questionnaire 3A.

Advantageously, once the statistically relevant data 5, 7, 8 and/or 9A have been stored in the database 6, the method of this invention provides evaluation of the second statistically relevant data 7 as a function of the first statistically relevant data 5 to assign each set 3E, 3C of said plurality of questions of the questionnaire 3A a weight for generating second statistically relevant weighted data 13.

This step of the method allows different weights to be identified for each set 3B, 3C of the questionnaire 3A, for instance, to account for ‘false positives’.

It shall be noted that the weights to be assigned to the various questions that form the sets 3B, 3C are defined using the first statistical technique 2A (Delphi) as well as through the heuristics 9 of the activity center.

Once the second statistically relevant weighted data 13 have been generated, the method of the invention includes a step of summary measurement 14 of said second statistically relevant weighted data 13 to determine a summary index 14A.

Hence, in a preferred embodiment of the present invention, the summary measure 14 is provided through a functional or weight-related analysis.

Particularly, such functional analysis provides evaluation of a judgment difference Δ between the ideal judgment 3D′ and a real judgment 3D″ and resealing of said difference Δ to a wider range as compared with the range of said ideal judgment 3D′ and/or said one real judgment 3D″, so that a summary index 14A can be generated for each set 3B, 3C of said questionnaire 3A to determine the actual weight of the specific question.

In other words, assuming, for example, that the scales for the ideal judgment 3D′ (importance) and the real judgment 3D″ (satisfaction) range from zero to five, the difference between said ideal judgment 3D′ (importance) and said real judgment 3D″ (satisfaction) may be as follows:

i) Δ=0 i.e. neutral judgment

ii) Δ>0, i.e. dissatisfaction of the customer/user with respect to the specific question of the questionnaire 3A;

iii) Δ<0, i.e. satisfaction of the customer/user with respect to the specific question of the questionnaire 3A.

It will be understood that Δ>0 may correspond to a satisfaction judgment and Δ<0 to a dissatisfaction judgment.

Furthermore, as described above, besides determination of the difference Δ, the summary measurement step may also include resealing of such difference Δ to a wider range.

In other words, assuming that the scales for the ideal judgment 3D′ (importance) and real judgment 3D″ (satisfaction) are from zero to five, the judgment for the difference Δ may be centered on the value of five, and may range from zero to ten.

It shall be noted that, by scaling the difference Δ, the summary measurement 14 may be avoided, as well as the need to interpret it to evaluate whether the summary index so generated is actually positive or actually negative.

Furthermore, it should be noted that, during such summary measurement 14, techniques may be applied to provide higher value to dissatisfaction as compared with satisfaction.

Particularly, certain dissatisfaction variables (i.e. certain questions of the sets 3B, 3C of questions of the questionnaire 3A) can have a value of 1.5 instead of 1. Conversely, certain satisfaction variable can have a value of 0.5 instead of 1.

Therefore, the summary index 14A can be used to evaluate the quality of the service delivered by the activity center, which may be available to the activity center administrator through the step 4 of generating a first report 15.

Particularly, the first report 15 contains at least one judgment represented in summary form, which falls within a range from a minimum value to a maximum value, depending on the previously determined difference Δ between the ideal judgment 3D′ (importance) and the real judgment 3D″ (satisfaction).

The judgment in the report 15 (not shown) may be expressed in alphanumeric form (e.g. from 1 to 9, or from very bad to excellent or vice versa), or in a graphic form that can be displayed on a computer monitor or a paper sheet with a color associated thereto (e.g. green to express a positive summary index 14A, red to express a negative summary index 14A, etc.).

Alternatively, the summary measure 14 may be obtained through a factor analysis, which can identify, below a set of correlated variables, latent dimensions, known as factors, which can reduce the noise of variables to be processed.

In other words, the summary measure 14 can only be obtained by determining a reduced set of linear combinations of the original variables which explain part of the variance of the variables.

Once the main factors have been found, they may be used instead of the initial variables, for segmentation-related selections and for any following analysis.

The factor analysis is useful to identify the main dimensions of each phenomenon and to apply the selected segmentation technique to a limited amount of data.

The inventive method further allows statistical association of the data contained in said first section 10, said second section 11 and said third section 12 of said database 6 with said summary index 14A to generate data 16 varying in a predetermined range of values.

It will be understood that the association step can be carried out ether manually by someone that is designed to evaluate the degree of association of the data contained in said first section 10, said second section 11 and said third section 12 of said database 6 with said summary index 14A or on an automatic basis.

The range of values within which the data 16 is contained may be either in alphanumeric form, e.g. from 1 to 5 or in judgment form, e.g. from very bad to excellent or vice versa.

This data 16 is representative of all information collected using the statistical technique 2A, the questionnaire 3A, the form 4A and the heuristics 9.

The data 16 is also stored in an appropriate section of the database 6 to be used over successive processings about the degree of satisfaction of the user to form a comparison database.

For the purposes of the present invention, to ascertain the degree of customer satisfaction with respect to the service delivered by the activity center, a threshold value Th is provided to discriminate, within the range of values of said data 16, those that are above said threshold value.

Once that such data above the threshold value Th is recognized, it can be processed to generate a second report 17.

The second report 17 will be represented both in aggregate and analytical forms.

Particularly, in the preferred embodiment, the second report 17 consists of a plurality of indicators whose values can be used to form dashboards (tachometers).

Referring to FIG. 4A, a form of second report 17 is shown, which may be represented as an arc of a circumference 17A describing a straight angle and having an indicator 17B designed to be placed on the points (e.g. from 0 to 9, from 0° to 180° or from very bad to excellent) of such arc of a circumference for timely indication of the degree of satisfaction of the customer/user with respect to the specific question of the questionnaire 3A.

In the specific representation of FIG. 4A, the arc of the circumference 17A provides vision with respect to the issue of AMBIENCE.

Also, with further reference to FIG. 4B, the second report 17 may be divided according to further structure data 10, to determine the specific report 17 for specific classes divided by kind (e.g. NEW PATIENTS and LOYAL PATIENTS and age (such as from 0 to 18, from 19 to 40, from 40 to 60, older than 60).

Therefore, the structure 10, as stored in the database 6 allows to determine the details of each indicator of the report 17 to recall the graphical interpretations of data correlation and corrective actions to be taken for each set of questions 3B and 3C.

For instance, the data represented by each indicator of the report 17 may be expressed as values and be hierarchically interconnected to reconstruct the path opposite to summary measurement (top down) and advantageously represents the source for the navigation and exploration environments for the activity center.

It shall be noted that the predetermined threshold value can discriminate the values below the preset threshold value in such data 16.

For example, if the range of values appropriately resealed through the functional summary measure as described above ranges from 1 to 9 and the threshold Th is set to 3, the customer satisfaction degree with respect to the service delivered by the activity center is positive for those data 16 above such threshold value Th.

A third report 18 may be thus generated, as shown in FIG. 5, which can provide information relating to the quality of the service offered by said activity center, said third report 18 comprising at least one non numerical judgment (Top Ten So) that can be represented by a summary notion.

The third report 18 can be only generated by processing the summary index 14A, the first statistically relevant data 5 and the cumulative data 20 as well as the values below said threshold value.

For this purpose, to obtain the cumulative data 20 the method advantageously includes the step of aggregating said fourth statistically relevant data 9A with the data contained in said first section 10 in said second section 11 and in said third section 12 of said database 6.

It will be understood that the aggregation step can be carried out ether manually by someone that is designed to evaluate the degree of aggregation of the data contained in said first section 10, said second section 11 and said third section 12 of said database 6 with said summary index 14A or on an automatic basis.

Advantageously, the non numerical judgment of the third report 18 comprises a first display area 18A which is preferably connected to the structure aspects of the activity center (LEARNINGS) and a second area 18B which is preferably specialized in the detail of the actions to be taken (ACTIONS) in response to specific activities that are deemed to be critical in terms of customer satisfaction (see FIG. 5).

In other words, the non numerical judgment of the third report 18 is embodied by a list 18C, which defines, for instance, a series of suggestions, such as the first ten suggestions, which are customized and generated in response to the previous steps of the inventive method.

This list of suggestions 18C readily indicate the key corrective actions to be taken to address the problems being encountered.

It shall be further noted that the present method also includes a step of generating a fourth report 19 (not shown), which is based on the processing of data contained in the third section 11 of the database 6.

The fourth report 19 displays a plurality of suggestions, e.g. ten suggestions, which are proposed in terms of absolute ratings, particularly relevant for aspects directly related to environmental aspects, accessory to the activity center.

It will be appreciated from the above that, once a statistically significant sample is achieved, the method of the invention allows use of a summary measure (using factor analysis or functional aggregative techniques) to express, among the results of the data deduced from the statistical technique 2A, the questionnaire 3A and the form 4A, the interpretations indicated by the reports 15, 17, 18, 19 on an automatic basis and the consequently suggested actions, and allows to fulfill the above requirement while obviating the drawbacks as mentioned in the introduction to this disclosure.

Those skilled in the art will obviously appreciate that a number of changes and variants may be made to the method and IT product as described hereinbefore, without departure from the scope of the invention, as defined in the following claims.

1. A method for acquiring, managing and processing information concerning the degree of customer satisfaction to provide information about the quality of the service offered by an activity center, said acquiring method comprising the steps of:
providing a database (6) containing first statistically relevant data (5), said first statistically relevant data having been acquired using a statistical technique (2A);
providing a questionnaire (3A) comprising a plurality of questions, a first set (3B) of said plurality of questions being related to the characteristics of said activity center and/or the degree of satisfaction of said user and a second set (3C) of said plurality of questions being related to the data of said user;
receiving second statistically relevant data (7) representative of the answers to the plurality of questions in said questionnaire (3A);
storing said second statistically relevant data (7) in said database (6);
characterized in that said method further comprises the steps of:
evaluating said second statistically relevant data (7) as a function of said first statistically relevant data (5) so that each set (3B, 3C) of said plurality of questions that form said questionnaire (3A) is assigned a weight for generating second statistically relevant weighted data (13);
providing a summary measure (14) of said second statistically relevant weighted data (13) to determine a summary index (14A), said summary index (14A) allowing evaluation of the quality of the service offered by said activity center, said summary index (14A) including at least one alphanumeric judgment in a range of values from a minimum value to a maximum value;
generating at least one first report (15) representative of said summary index (14A).

2. A method for acquiring, managing and processing information as claimed in claim 1, wherein said step of providing a summary measure (14) comprises the step of performing a functional analysis, which can be performed through a step of evaluation of a difference value Δ between an ideal judgment (3D′) and a real judgment (3D″), the latter being expressed by filling out said questionnaire (3A).

3. A method for acquiring, managing and processing information as claimed in claim 2, wherein said step of evaluation of the difference value (Δ) comprises a step of resealing said difference (Δ) to a wider range as compared with the range of said ideal judgment (3D′) and/or said one real judgment (3D″), so that a summary index (14A) can be generated for each set (3B, 3C) of said questionnaire (3A).

4. A method for acquiring, managing and processing information as claimed in claim 2 or 3 wherein, if said difference value (Δ) is zero, then said evaluation step corresponds to the expression of a neutral judgment by the customer/user with respect to the specific question of said sets of questions (3B, 3C) of said questionnaire (3A).

5. A method for acquiring, managing and processing information as claimed in claim 2 or 3 wherein, if said difference value (Δ) is a positive value, then said evaluation step corresponds to the expression of a dissatisfaction judgment by the customer/user with respect to the specific question of said sets of questions (3B, 3C) of said questionnaire (3A).

6. A method for acquiring, managing and processing information as claimed in claim 2 or 3 wherein, if said difference value (Δ) is a negative value, then said evaluation step corresponds to the expression of a satisfaction judgment by the customer/user with respect to the specific question of said sets of questions (3B, 3C) of said questionnaire (3A).

7. A method for acquiring, managing and processing information as claimed in any one of claims 2 to 6, wherein said method further comprises the steps of:
receiving third statistically relevant data (8) representative of the spontaneous suggestions of said user with respect to issues that are not covered by said plurality of questions of said questionnaire;
storing said third statistically relevant data (8) in said database (6);
said questionnaire (3A) comprising a third set of questions (3E) of said plurality of questions (3B, 3C), which is related to suggestions provided by said user, said database (6) comprising a first section (10) for storing the structure data of said second statistically relevant data (7), a second section (11) for storing the answers of said second statistically relevant data (7) and a third section (12) for storing the sum of said third statistically relevant data (8) and the suggestions of said third set of questions of said questionnaire (3A).

8. A method for acquiring, managing and processing information as claimed in claim 7, wherein said method further comprises the steps of:
associating the data contained in said first section (10), said second section (11) and said third section (12) of said database (6) with said summary index (14A) to generate processed data (16) varying in a range from a minimum value to a maximum value;
providing a threshold value (Th) to discriminate, within said range of values of said processed data (16), those that are above said threshold value;
processing said values above said threshold value to generate a second report (17).

9. A method for acquiring, managing and processing information as claimed in claim 7, wherein said method further comprises the steps of:
receiving fourth statistically relevant data (9A) representative of the heuristics of said activity center;
said database (6) comprising a fourth section to store said fourth statistically relevant data (9A) of said activity center;
aggregating said fourth statistically relevant data (9A) with the data contained in said first section (10), said second section (11) and said third section (12) of said database (6), to obtain the cumulative data (20);
processing said summary index (14A), said first statistically relevant data (5), said cumulative data (20) and the values below said threshold value to generate a third report (18), said third report (18) comprising at least one non numerical judgment (Top Ten So), which comprises a first graphics area (LEARNINGS) related to the structural aspects of said activity center and a second graphics area (ACTIONS) with details of the actions to be taken in response to specific activities that are deemed to be problematic in view of the customer satisfaction degree.

10. A method for acquiring, managing and processing information as claimed in claim 7, further comprising the steps of:
processing the data of said third section (12) of said database (6) to generate a fourth report (19);
said fourth report (19) being adapted to provide information concerning the quality of the service offered by said activity center with respect to issues that are not covered by said plurality of questions of said questionnaire, said fourth report comprising at least one non numeric judgment (Top Ten Su).

11. A method for acquiring, managing and processing information as claimed in claim 1, wherein said step of providing a summary measure comprises the step of applying functional aggregative techniques.

12. A method for acquiring, managing and processing information as claimed in claim 1, wherein said step of providing a summary measure (14) comprises the step of performing a factor analysis of said second statistically relevant weighted data (13) to identify, in each set of said plurality of questions, a smaller set of linear combinations within said second statistically relevant data (7) to determine said summary index (14A).

13. A method for acquiring, managing and processing information as claimed in any preceding claim, wherein said statistical technique (2) is a Delphi and/or Focus Group technique.

14. A method for acquiring, managing and processing information as claimed in any preceding claim, wherein said range of values is expressed by an alphanumeric notation.

15. A method for acquiring, managing and processing information as claimed in any preceding claim, wherein said activity center is a dental center.

16. An IT product designed to be directly loaded into the memory of a computer system, comprising program code portions, and adapted to carry out the method as claimed in any one of claims 1 to 15, when it runs on said computer system.
